(19) United States
(12) Patent Application Publication
(10) Pub. No.: US 2003/0048490 A1
(43) Pub. Date: Mar. 13, 2003

(54) Image recognizing apparatus

(76) Inventors: Yasushi Yanagihara, Owariasahi (JP); Hiroyuki Okuda, Ikeda (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/206,986

(22) Filed: Jul. 30, 2002

(30) Foreign Application Priority Data
Sep. 7, 2001 (JP) 2001-271211

(51) Int. Cl. H04N 1/04

(52) U.S. Cl. 358/474

(57) ABSTRACT

In an image recognizing apparatus in which a plurality of stand-type image scanners using environmental light are connected respectively to client computers and the client computers are connected via a network to each other, when a scanner is started, the client computer connected thereto reads the event of start and reads in response thereto light intensity information of the associated scanner and light intensity information of one of the other scanners via its associated client computer and the network to determine light intensity. When the light intensity of the associated scanner is insufficient and that of the other scanner is sufficient, the client computer reads again light intensity information after a lapse of a predetermined period of time.

### BACKGROUND OF THE INVENTION

The present invention relates to an image recognizing apparatus to recognize characters and letters on a medium such as a form image and to a stand-type image scanner.

An optical character recognition (OCR) has been known as a technique in which an image scanner reads an image of a form or a slip to produce information of characters in the image and a character recognizing or recognition software of a client computer recognizes the characters according to the information thereof. The image scanner used in the OCR technique can operate as a single device to obtain image data with predetermined quality in any situation for the following reason. The scanner includes a lighting device integrated therein to emit light onto a medium. Light reflected on the medium is directly received by a charge-coupled device (CCD) of the scanner to produce image data.

Recently, an image scanner of stand type has been used in the OCR technique. The stand-type image scanner does not includes its own lighting device, uses environmental lighting as its light source. Light reflected on a medium is received through a lens unit in the scanner to be received by a CCD unit. In short, the scanner operates according to the principle of digital cameras. Therefore, when the environmental lighting changes due to any change in a shadow of a human or the sunlight or due to deterioration of a lighting device, the scanner cannot be appropriately used depending on cases. Additionally, since binary parameters necessary to produce an image for recognition are represented as fixed values, the image produced for recognition considerably varies in quality.

Specifically, in a banking branch system of a bank, when a stand-type image scanner is connected to a teller's terminal in a branch of the bank, it is required to beforehand check intensity of illumination in the branch to confirm that the environmental illumination is stable for the image scanner. In such a system, when any illuminating condition varies, the maintaining engineer adjusts a white balance of the image scanner. In this way, when operate stand-type image scanners are used in the system, operating conditions of the overall system must be strictly stipulated.

Also, when image scanners are connected to a plurality of client computers on a network, it does not occur that the client computers collaboratively operate in the OCR processing.

### SUMMARY OF THE INVENTION

According to one aspect of the present invention, there are provided an image recognizing apparatus and a stand-type image scanner for use with the image recognizing apparatus in which a plurality of stand-type image scanners using environmental lighting or illumination are respectively connected to client computers and the client computers are mutually connected via a network to each other and in which processing is executed, when the environmental illumination changes, according to the change in the environmental illumination.

According to another aspect of the present invention, there is provided an image recognizing apparatus in which a plurality of stand-type image scanners using environmental lighting are respectively connected to client computers and the client computers are mutually connected via a network to each other and which can recognize any change of the environmental illumination.

According to further another aspect of the present invention, there is provided an image recognizing apparatus in which a plurality of standtype image scanners using environmental lighting are respectively connected to client computers and the client computers are mutually connected via a network to each other and which can increase a recognition rate in the image recognition.

According to the present invention, there is provided an image recognizing apparatus in which a plurality of stand-type image scanners using environmental lighting are respectively connected to client computers and the client computers are mutually connected via a network to each other. When a standtype image scanner is started, a client computer connected to the stand-type image scanner reads information of the start thereof. In response to the read of the start information, the client computer reads information of lighting or illumination of the stand-type image scanner and information of lighting of the other stand-type image scanners via the network and the other client computers to determine intensity of illumination of the lighting. When the illumination of the stand-type image scanner is insufficient and that of the other stand-type image scanners is sufficient, information of lighting of the stand-type image scanner is again read after a lapse of a predetermined period of time.

According to the present invention, there is provided a stand-type image scanner using environmental lighting in which a start of the image scanner is notified to a client computer connected to the image scanner. The image scanner notifies, in response to an instruction from the client computer, information of illumination to the client computer. The image scanner notifies again, in response to an instruction received from the client computer after a lapse of a predetermined period of time, information of illumination to the client computer.

According to the present invention, there is provided a stand-type image scanner using environmental lighting which measures intensity of illumination at a predetermined interval of time and stores latest information of intensity of illumination. A start of the image scanner is notified to a client computer connected to the image scanner. The image scanner notifies, in response to an instruction from the client computer, the latest information of intensity of illumination to the client computer. The image scanner notifies again, in response to an instruction received from the client computer after a lapse of a predetermined period of time, the latest information of intensity of illumination at a point of the instruction to the client computer.

According to the present invention, there is provided an image recognizing apparatus in which a plurality of stand-type image scanners using environmental lighting are respectively connected to client computers and the client computers are mutually connected via a network to each other. When a stand-type image scanner is started, a client computer connected to the stand-type image scanner reads information of the start thereof. In response to the read of the start information, the client computer reads information of lighting of the stand-type image scanner and information of lighting of the other stand-type image scanners via the network and the other client computers to determine intensity of illumination of the lighting. The client computer notifies results of determination of intensity of illumination of the stand-type image scanner and that of the other standtype image scanners to a server connected to the internet.

According to the present invention, there is provided an image recognizing apparatus in which a plurality of stand-type image scanners using environmental lighting are respectively connected to client computers and the client computers are mutually connected via a network to each other. When a standtype image scanner is started, a client computer connected to the stand-type image scanner reads information of the start thereof. In response to the read of the start information, the client computer reads information of lighting of the stand-type image scanner and information of lighting of the other standtype image scanners via the network and the other client computers to determine intensity of illumination of the lighting. When the illumination of the standtype image scanner is insufficient and that of the other stand-type image scanners is sufficient, the client computer reads again information of illumination of the stand-type image scanner again after a lapse of a predetermined period of time. When the illumination of the stand-type image scanner is sufficient, the client computer produces an image for recognition using image information read from the stand-type image scanner and binarizing parameters and recognizes characters using the image for recognition. The client computer stores results of the recognition together with a type of the image for recognition, the intensity of illumination, and the binarizing parameters.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a system configuration of a banking branch system using an image recognizing apparatus according to the present invention;

FIG. 2 is a diagram showing a configuration of an embodiment of an image reader device shown in FIG. 1;

FIG. 3 is a perspective view showing an appearance of a stand-type image scanner;

FIG. 4 is a diagram showing a circuit configuration of a stand-type image scanner;

FIG. 5 is a diagram showing a processing program of control software in a client computer;

FIG. 6 is a diagram showing an example of description of a correlational information file in a client computer; and

FIG. 7 is a flowchart showing operation of control software of a client computer.

### DESCRIPTION OF THE EMBODIMENTS

Description will now be given of an embodiment of the present invention by referring to the drawings.

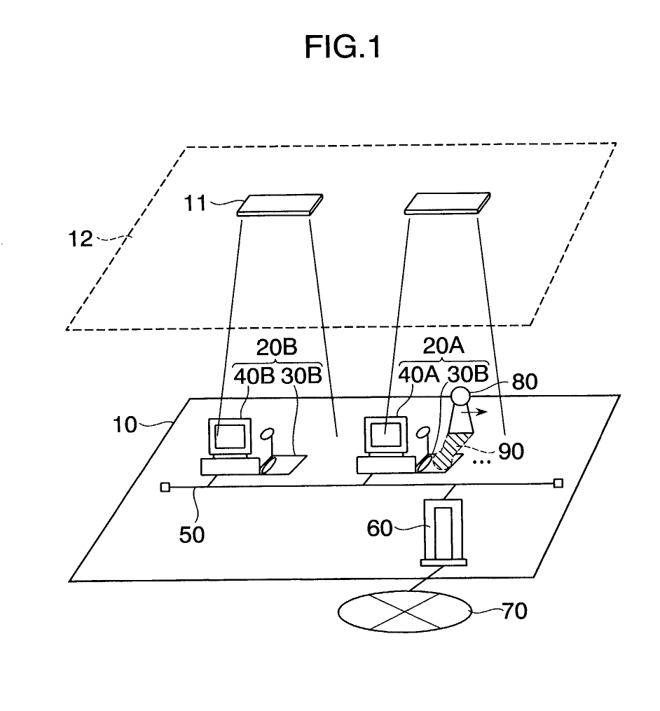

FIG. 1 shows a banking branch system using an image recognizing apparatus of the present invention. The branch system in the embodiment operates in an operation environment of a closed space such as a branch 10 in which lighting devices 11 having mutually similar characteristics are installed on a ceiling 12 of the branch 10. A plurality of image recognizing apparatuses 20 are installed adjacent to each other. The apparatuses 20A and 20B respectively include image scanners 30A and 30B and client computers 40A and 40B. The image scanner 30A is connected to the client computer 40A and the image scanner 30B is connected to the client computer 40B. The client computers 40A and 40B are mutually connected via a local area network (LAN) 50 to each other. The LAN 50 is also connected to a server computer 60. The computer 60 is disposed to transmit transaction results of the client computers 40A and 40B via a wide area network 70 or a leased communication line to a center, not shown.

The image scanner 30 operates using environmental illumination. Therefore, in the branch 10 or the like in which humans move from one place to another place, a person possibly becomes a hindrance 80 such that the hindrance 80 casts a shadow 90 on the image scanner 30 depending on cases. In this situation, the image scanner 30 cannot read an image because of insufficient illumination. On the other hand, when the illuminating device 11 is turned off and intensity of illumination becomes insufficient, the image scanner 30 cannot read an image. When only one stand-type image scanner 30 is used, it is difficult to discriminate between these cases of insufficient illumination. In the system of the embodiment according to the present invention, a second stand-type image scanner 30 adjacent to the pertinent image scanner 30 is also used. That is, the pertinent image scanner 30 obtains via the LAN 50 information of illumination read by the second image scanner 30 and determines a state of illumination using the information.

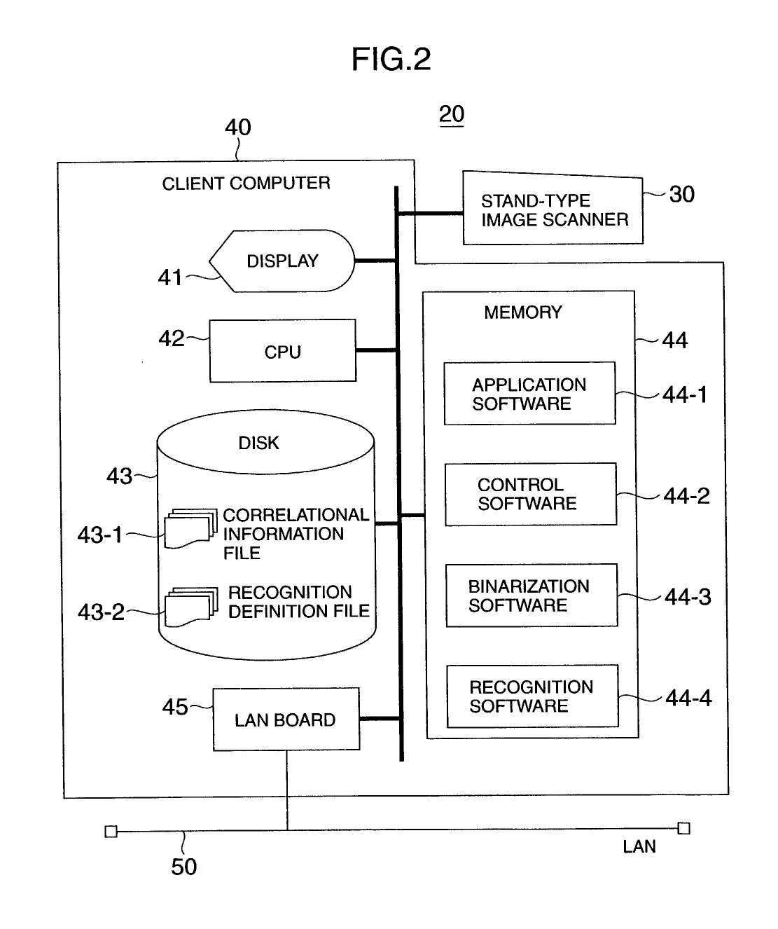

FIG. 2 shows a configuration of one image recognizing apparatus 20 of FIG. 1. The other image recognizing apparatus 20 is also configured in the same way as for the apparatus 20.

The client computer 40 includes a display 41, a central processing unit (CPU) 42, a disk 43, a memory 44, and an LAN board 45. The display 41 is an output device to present various warning messages and notifications. The CPU 42 is a control unit to control various operations and processing such as a reading operation and an OCR processing according to software in the memory 44. The LAN board 45 is a communication controller to conduct communication with, for example, another image recognizing apparatus connected to the network.

The disk 43 stores a correlational information file 43-1 and a recognition definition file 43-2. In an initialization stage, the CPU 42 loads application software 44-1, control software 44-2, binarization software 44-3, and recognition software 44-4 into the memory 44. These software is stored on the disk 43. The LAN board 45 is connected to the LAN 50.

The client computer 40 is connected to the stand-type image scanner 30. The control software 44-2 in the memory 44 of the client computer controls the image scanner 30. The binarization software 44-3 and the recognition software 44-4 are software modules to be initialized under control of the control software 44-2.

The binarization software 44-3 has a function to convert a gray scale image produced by the image scanner 30 into a binary image to be processed by the recognition software 44-4. A binarization parameter is a condition value to classify each element of the gray scale image into two values respectively representing a white pixel and a black pixel according to various threshold values. To generate a binary image under a different condition, a new binarization parameter is fed to the binarization software 44-3 when the conversion is started.

The recognition software 44-4 has a function to recognize character information of a recognition field contained in the image by using a recognition image produced by the binarization software 44-3 and the recognition definition file 43-2 containing recognition information for each slip or form.

The control software 44-2 executes the OCR processing at depression of a scanner start button of the image scanner 30. In the OCR processing, an image is read and is converted into a gray scale image. The binarization software 44-3 binarizes the gray scale image. Using the binarized image and the recognition definition file 43-2, the recognition software 44-4 recognizes characters in the image.

In the embodiment of the present invention, the disk 43 has the correlational information file including information of correlation between information of illumination, binarization parameters, and values of the character recognition rate. These information items are used as control conditions of the OCR processing. Results of recognition obtained through a sequence of OCR processing are notified to the application software 44-1 and are used as input information of application processing.

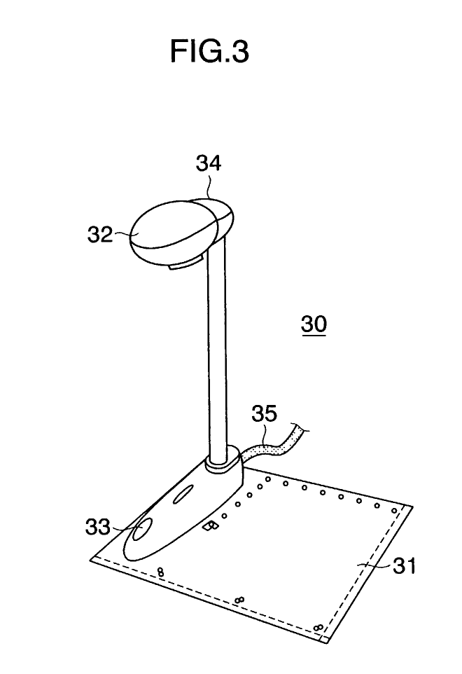

FIG. 3 shows an appearance of a stand-type image scanner 30 employed in the embodiment. The image scanner 30 operates according to a principle of operation of digital cameras and includes a reading plate 31 on which a slip to be read is placed and a scanner head section 32 to read an image of the slip. The slip placed on the reading plate 31 is shot by a CCD sensor disposed in a camera unit integrally installed in the scanner head section 32.

Each of the image scanners 30A and 30B includes a scanner start button 33 and an optical sensor 34. To start a reading operation, the operator depresses the scanner start button 33. When the button 33 is depressed, the condition is notified via a cable 35 to the client computer 40 shown in FIG. 2. The CPU 42 instructs using the control software 44-2 an image read operation to the image scanner 30 shown in FIG. 3 to obtain image information read by the scanner 30.

The optical sensor 34 is used to measure intensity of illumination at a point near the scanner 30. In the image read operation, the scanner 30 must receive the intensity of illumination measured by the sensor 34 to determine whether or not an image can be normally read under the condition. In the embodiment, the client computer 40 of FIG. 2 first obtains image information according to an image read indication from the control software 44-2 and then reads the information of illumination.

In the embodiment, the image scanner 30 measures intensity of illumination at an interval of, for example, 30 milliseconds (ms) and stores latest information of illumination intensity in its memory. When the start button 33 is depressed, the image 30 scanner notifies the latest information of illumination intensity stored in the memory to the client computer 40. The client computer 40 reads the notification of depression of the start button. After a lapse of, for example, 50 ms, the client computer 40 instructs an image read operation to the image scanner 30 to read an image. After a lapse of, for example, 50 ms, the latest information of illumination intensity is read to be stored in the memory. The client computer 40 checks the image information and the information of illumination intensity. The operation to read the information of illumination intensity may be conducted before the operation to obtain the image information.

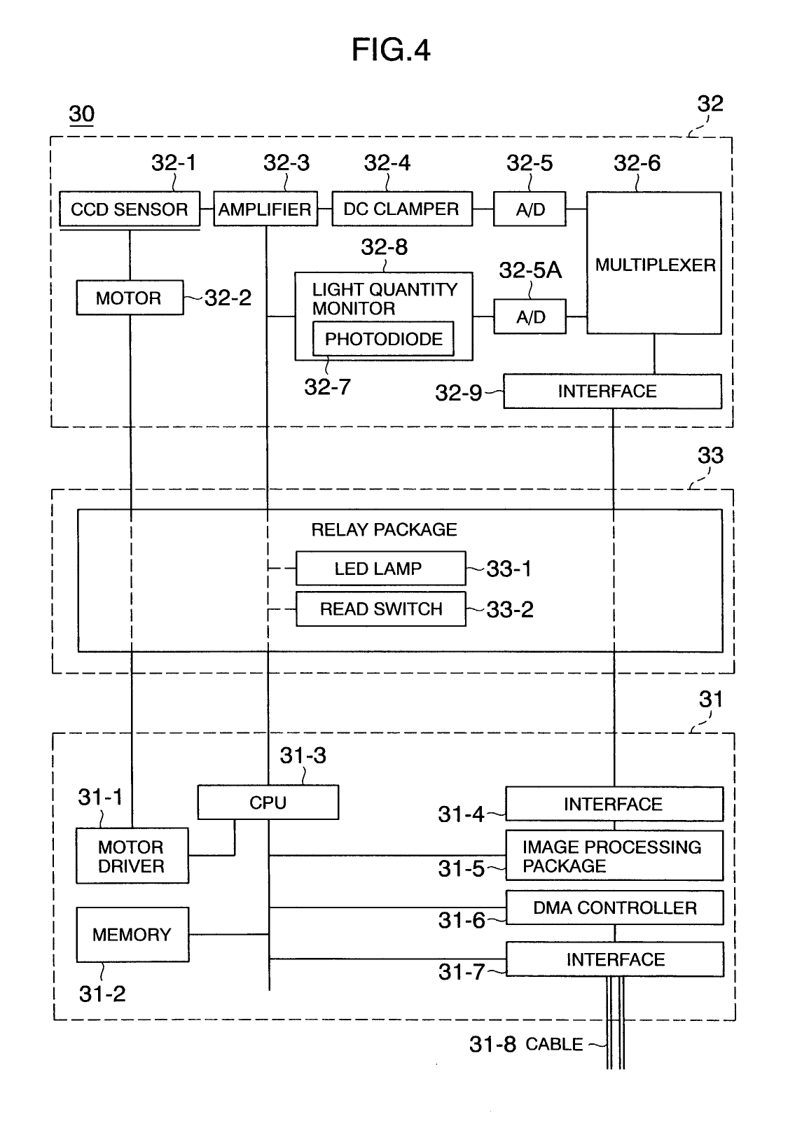

Description will be given in detail of the image scanner 30 by referring to FIG. 4. FIG. 4 shows a circuit configuration of the image scanner 30. The circuit configuration of the image scanner 30 mainly includes a plate section 31, a scanner head section 32, and a control box section 33.

Operation of the image scanner 30 will be described by paying attention to an image recognizing apparatus 20 (the image scanners 30A and the client computer 40A) to which the operator has issued a request for a read operation.

The scanner head section 32 of the image scanner 30A includes a photodiode 32-4 as the optical sensor 34 to sense intensity of light of the environmental illumination. Light received by the photodiode 32-4 is fed to a light quantity monitor circuit 32-8 and is outputted therefrom as an electric signal. The signal is produced as an analog signal. The analog signal is converted by an analog-t-digital (A/D) converter 32-5 into a digital signal. The digital signal is fed to a multiplexer 40-6 and is transmitted to a control box section 42. The digital signal is transmitted via interfaces 32-9 and 32-4.

In the control box section 42, a CPU 31-3 receives the digital signal via an image processing package 31-5. The digital signal is stored as information of intensity of light in a memory 31-2. The CPU 31-3 issues a read instruction to the photodiode 32-7 at an interval of 30 ms and reads information of intensity of light from the photodiode 32-7 at an interval of 30 ms to store the information in the memory 31-2.

When the image scanner 30A is normally operating, a light emitting diode (LED) lamp 33-1 is on. When the operator depresses the start button 33 and hence a read switch 33-2 is depressed, the CPU 31-3 recognizes the depression of the button by an event in which a signal indicating a state of the button is changed from on to off. The CPU 31-3 notifies the depression of button via a cable 31-8 to the control software 44-2 of the client computer 40. In the own client computer 40A, the control software 44-2 reads the notification of the depression of button. After a lapse of 50 ms, the software 44-2 instructs the associated image scanner 30A to read an image.

In the image scanner 30A, the CPU 31-3 reads the image read instruction and issues a read start instruction to a motor driver circuit 31-1. The motor driver 31-1 drives a motor 32-2 at timing of the read start instruction to move a CCD sensor 32-1 in a parallel displacement. The CCD sensor 32-1 is a CCD sensor disposed in a camera unit integrally arranged in the scanner head section 32 shown in FIG. 3. The CCD sensor 32-1 receives via a lens light reflected on a slip. Since the sensor 32-1 reads one line of the slip at a time, the sensor 32-1 is moved by the motor 32-2 to sequentially read information of the lines sufficient to produce an image of the slip.

The analog signal 32-1 from the CCD sensor 32-1 is amplified by an amplifier 32-3 and is then converted via a direct-current (DC) clamper 32-4 and an analog-to-digital (A/D) converter 32-5 into a digital signal. The digital signal is sent via the interfaces 32-9 and 31-4 to the image processing package 31-5. The package 31-5 conducts correction for noise and distortion of the image in the information of the slip image. The CPU 32-3 activates a direct memory access (DMA) controller 31-6 such that the image information from the scanner head 32 is transferred under control of the controller 31-6 via an interface 31-7 and a cable 31-8 to the associated client computer 40A.

In the client computer 40A, when a period of time of 50 ms lapses, the control software 44-2 issues an image information request to the image scanner 30 to read information of intensity of light.

Having received the request from the control software 44-2 of the client computer 40, the CPU 31-3 of the associated image scanner 30A reads the information of intensity of light from the memory 31-2 and sends the information via the interface 31-7 and the cable 31-8 to the client computer 40A.

Next, description will be given of operation of another image recognizing apparatus (including a stand-type image scanner 30B and a client computer 40B) connected via the LAN to the image recognizing apparatus 20 to which an image read operation is instruction. The image scanner 30B and the client computer 40B are configured respectively in the same fashion as for the image scanner 30A and the client computer 40A connected thereto.

When the client computer 40A reads the image information and the light intensity information from the image scanner 30A, the client computer 40A also issues an instruction to the client computer 40B to read the image information and the light intensity information from the image scanner 30B. In response to the instruction, the CPU 31-3 of the image scanner 30B conducts an associated read operation and sends the image information and the latest information of intensity of light in the memory 31-2 via the LAN 50 to the client computer 40A in the same way as for the image scanner 30A. In this way, when the start button 33 of the image scanner 30A is depressed, the image information and the light intensity information of the image scanner 30A and those of the image scanner 30B are obtained to be sent to the control software 44-2 of the client computer 40. The software 44-2 checks the image and the intensity of light. The image is checked according to, for example, a threshold value for an image condition. When the threshold value is exceeded, the image is regarded as “acceptable”. Otherwise, the image is regarded as “not acceptable”.

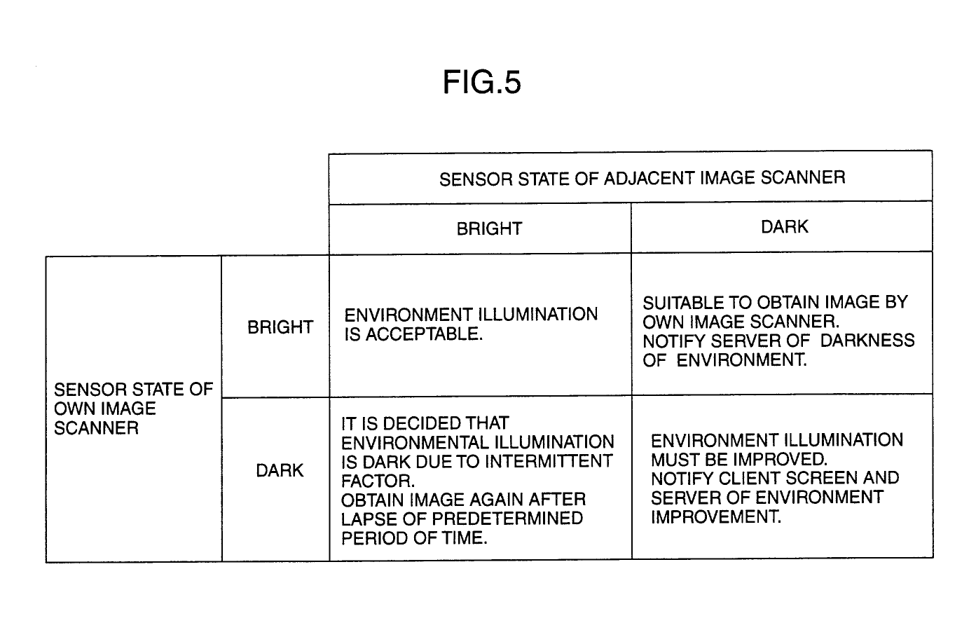

FIG. 5 shows a processing program of the control software 44-2 in the client computer 40A of FIG. 2. The program specifically processes the information of light intensity measured by the optical sensor 34 of the image scanner 30A and that measured by the optical sensor 34 of the image scanner 30 of the client computer 40B, the image scanner 30 being adjacent to the image scanner 30A. Assume that the threshold value of the light intensity condition for an appropriate operation is, for example, 500 lux. When the threshold is exceeded, the light intensity is regarded as “bright”. Otherwise, the light intensity is regarded as “dark”.

As shown in FIG. 5, when the intensity of light is bright for the own image scanner and the adjacent image scanner, the light intensity condition is acceptable in the branch 10 of FIG. 1 and hence the image information beforehand obtained can be used to recognize characters in the image. when the intensity of light is dark for the own image scanner and that for the adjacent image scanner is bright, it is assumed that the light intensity becomes intermittently insufficient by a hindrance 80 such as a person only in the vicinity of the own image scanner. After a predetermined period, for example, one second lapses, an instruction is again issued to read the image information and the light intensity information.

When the intensity of light is bright for the own image scanner and that for the adjacent image scanner is dark, the own scanner can normally read an image. However, it is assumed that the environment in the branch is dark, and hence the condition is notified as a warning message to the server computer 60. The server computer 60 collects information of the warning message to statistically manage, for example, a tendency of variation in the light intensity of the branch.

When the intensity of light for the own image scanner and that for the adjacent image scanner are dark, it is assumed that the environment in the entire branch area is dark. Therefore, a message to improve the environmental illumination is presented on a screen of the client computer or the condition is notified as a warning message to the server computer 60.

In this way, by obtaining the information of light intensity at a plurality of positions in the branch 10, the state of illumination can be more comprehensively determined when compared with the operation using the information of light intensity at only one position. Therefore, it is possible to more efficiently operate the stand-type image scanner 30 depending on the environment.

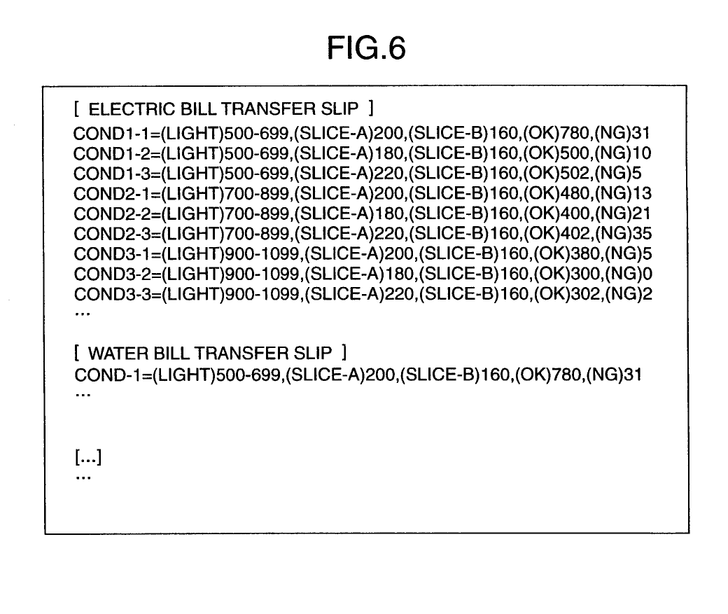

FIG. 6 shows an example of the contents of the correlational information file 43-1. The contents of the file 43-1 are produced as follows. A gray scale image obtained by the image scanner 30 is binarized by the binarization software 44-3 of the client computer 40 shown in FIG. 2. The recognition software 44-4 then recognizes characters of the image and collects results of the recognition in the file 43-1. The correlational information file 43-1 stores records for each slip type (a section indicated by []). Each entry of the record includes an item of light intensity information (LIGHT), an item of information of binarization parameters (SLICE-A/SLICE-B), and the number of positive replies (OK) and that of negative replies (NG) for the combination of the preceding items.

The record can be interpreted as an item representing a recognition rate of a condition parameter externally used. By accumulating the correlational information, it is possible in the OCR processing to know combinations of condition parameters for a higher character recognition rate. In the OCR processing, the slip type is determined by an application or a job and the intensity of light is determined by the environmental illumination. Therefore, among the variables changeable in the internal programs, binarization parameters can be changed. By referring to the correlational information file 43-1 in the execution of the OCR processing, the control software 44-2 can select binarization parameter values to convert a gray scale image into an image for recognition to resultantly increase the character recognition rate.

Using the correlational information file 43-1 as above, even when the environmental illumination varies during the operation of the stand-type image scanner 30, the binarization parameters can be automatically determined to prevent any adverse factors or noise in the OCR processing.

In the system installed in the branch 10, each of the client computers 40 and 41 updates the correlational information file 43-1 during the OCR processing. However, in general, reliability of information contained in the file 43-1 is higher as the amount of the information becomes greater. Therefore, to increase the amount of information, the system may be operated as follows. When a predetermined amount of information is accumulated in the correlational information file 43-1 of the client computer 40, the client computer 40 distributes the file 43 to the other client computers 40B. Each client computer 40 combines its own correlational information file 43-1 with the received correlational information file 43-1.

Another operation mode is also possible in which the correlational information file 43-1 is not directly sent to the other client computers 40. The correlational information file 43-1 is sent to a server computer 50 to manage the file 43-1 in a centralized manner. During the OCR processing, each client computer 40 refers to the file 43-1 managed by the server computer 50.

On the other hand, another management method may be possible in which the client computers 40 shares the correlational information file 43-1. The contents of the correlational information files 43-1 is not shared among the respective client computers 40. The amount of information of the correlational information file 43-1 varies between the client computers 40. That is, when the client computer 40 executes the OCR processing, the client computer 40 sends a gray scale image to the client computer 41 such that characters are recognized using the correlational information files 43-1 respectively stored in the client computers 40 and 41. The client computer 40 obtains only results of the character recognition and collates the obtained results with those from its own processing.

In this situation, the character recognition is accomplished using the correlational information file 43-1 respectively containing the different amounts of information. Therefore, reliability of the results from the character recognition also varies therebetween. By determining the results of character recognition according to decision by majority, precision of the character recognition rate will be improved.

The former using a shared correlational information file the latter determining the results of character recognition decision by majority can be achieved by systematically combine a plurality of image scanners with each other in a network environment. For control of devices depending on the external environment, reliability of information can be increased in a system in which the devices are classified into groups to be managed via a network when compared with a system in which each device is individually managed. Moreover, efficiency of the system operation can also be increased.

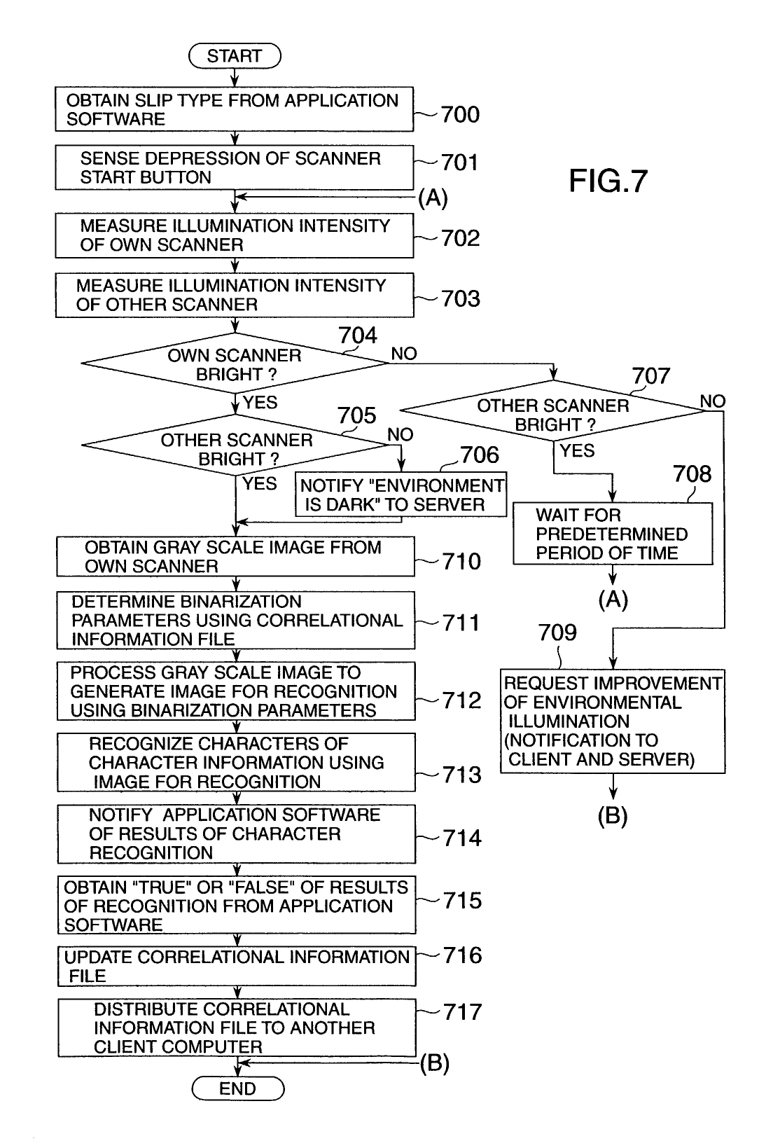

FIG. 7 shows processing of the control software 44-2 in the client computer 40 of FIG. 2 in a flowchart. Description will now be given of a concrete processing flow by referring to FIG. 7.

In step 700, a slip type is received from an application software. In step 701, according to detection of a state of depression of the scanner start button by the operator, a program logic is executed to conduct the OCR processing.

In the OCR processing (steps 702 to 709), various processing described in conjunction with FIG. 7 is executed. First, in steps 702 and 703, intensity of light is measured in the vicinity of the image scanners 30A and 30B.

In steps 704 to 709, using the values obtained by the measurement, processing is executed according to the control matrix shown in FIG. 5 and the states of illumination of the image scanners 30A and 30B, respectively. If the image scanner 30A has a condition of illumination suitable to read an image (i.e., the sensor state is “bright”), a gray scale image is received from the associated image scanner.

Otherwise (i.e., the sensor state of the image scanner 30A is “dark”), control goes to step 707. In step 707, a check is made according to the sensor state of the scanner 30B obtained in step 603 whether or not the image scanner 30B in the vicinity of the image scanner sensor 30A is in a “bright” condition. If the sensor state of the image scanner 30B is “bright”, the processing is again executed beginning at step 703 after a lapse of predetermined period of time, for example, one minute (step 708). Otherwise, control goes to step 609 to request improvement of the environmental illumination.

In step 711, the gray scale image is converted into a binary image for recognition using a binarization parameter. The program reads the correlational information file 43-1 to determine the binarization parameters according to the contents of the file. Two external parameters of the slip type information and the light intensity information have already been determined through the steps up to this point. Therefore, the remaining external parameter, namely, information of the binarization parameters is to be determined. From the correlational information file 43-1, several conditional items matching the external parameters of slip type and light intensity can be obtained.

These items are sorted in an ascending order of the number of samples (the sum of the number of positive answers and that of negative answers). From the items for which the difference between the maximum number of samples and the minimum number of samples is equal to or more than 20 percent of the maximum number of samples, a binarization parameter is selected to maximize the recognition rate. From the items for which the difference is less than 20 percent of the maximum number of samples, another condition is used.

The processing above is used to prevent an event in which there occurs deviation in the correlational information when the items associated with only the maximum recognition rate are selected. When the difference is less than 20 percent, the conditional items of the minimum number of samples are taken into consideration. If each of the conditional items is associated with a recognition rate equal to or more than 80 percent, a binarization parameter corresponding to the item is used. If the conditional item is associated with a recognition rate less than 80 percent, the conditional items of a second minimum number of samples are taken into consideration to similarly conduct the processing above.

In this method, there is obtained a binarization parameter satisfying a request to guarantee a practical recognition rate and a request to prevent deviation in the information of the correlational information file.

Using the binarization parameter obtained in step 711, the gray scale image is converted into a binary image for recognition in step 712. In step 713, the recognition software 44-4 is activated to recognize characters in the image. In step 714, results of the character recognition is notified to the application software 44-1. In step 715, the application software 44-1 converses with the operator on its screen. In step 714, the application software 44-1 requests the operator to determine whether the results of the character recognition is acceptable or not to thereby obtain a result of the determination from the application software 44-1.

In step 716, whether the results of the recognition in step 713 are acceptable or not can be determined using the information of “true” and “false” obtained from the application software 44-1. The “true” or “false” (ON/NG) is used to update the correlational file 43-1.

In step 717, when the update is conducted a predetermined number of times, the updated contents of the correlational information file are sent via the LAN 50 to another client computer so that the contents are combined with those of the correlational information file thereof and are used as shared information.

As above, the stand-type image scanner obtain an image using the environmental illumination as its optical source. However, any variation in an external factor such as the environmental illumination exerts adverse influence upon operation of the image scanner. Therefore, to operate the system, it has been required to stipulate strict conditions, for example, to install the image scanner. However, in the system in which a plurality of stand-type image scanners are used in a network environment such as an LAN as in the embodiment, intensity of light can be gathered from the optical sensor of each image scanner and hence the state of intensity of light in a closed space of a branch or the like can be in an area, not at each point. As compared with the system in which the image scanner is individually operated, the system in which a plurality of image scanners are operated as above leads to an advantage as follows. When intensity of light is insufficient in the vicinity of a first client computer, it can be more correctly determined whether or not the state of insufficient light intensity is an intermittent abnormal state by referring to a state of light intensity in the vicinity of a second client computer near the first client computer.

Moreover, since the information of light intensity obtained by each client computer is periodically sent to the server computer, the server computer can manage the information in the unit of time of hour, day, or week in a centralized way. It is therefore possible to obtain a tendency of variation in the intensity of light in the branch. The information of the tendency can be used to appropriately conduct the maintenance of the lighting apparatuses in the branch.

For the operation as the OCR device to obtain an image of a slip to recognize information of characters in the image, each client computer has a function to automatically collect a correlation between the slip type, intensity of light, binary parameters, and the character recognition rate. The correlational information can be used to select the binarization parameter to increase the character recognition rate. By distributing the correlational information to the other client computers or by providing a system to manage the correlational information centrally by the server computer in a centralized way, the correlational information of each client computer can be commonly used. Therefore, precision of the character recognition can be improved in the client computers. On the other hand, it is also possible that the client computers do not shared the correlational information, but the gray scale image is distributed to each client computer in the processing of character recognition. Each client computer obtains results of the character recognition using the correlational information. By collating the character recognition results between the clients, final results are determined. This also improves precision of the character recognition.

In this way, by using a system in which the stand-type image scanners are logically or systematically connected via a network to each other to share management information or a system in which the information is not shared, but the processing results of the respective devices are collated to obtain final results to increase precision thereof, it is possible to increase efficiency of the system operation.

According to the present invention, there are provided an image recognizing apparatus and a standtype image scanner for use with the image recognizing apparatus in which a plurality of stand-type image scanners using environmental lighting or illumination are respectively connected to client computers and the client computers are mutually connected via a network to each other and in which processing is executed, when the environmental illumination changes, according to the change in the environmental illumination. Additionally, according to the present invention, there is provided an image recognizing apparatus which can recognize any change of the environmental illumination. Moreover, according to the present invention, there is provided an image recognizing apparatus which can increase a recognition rate in the image recognition.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An image recognizing apparatus, comprising:
an image scanner having;
a sensor for obtaining an image of a slip and
a light intensity sensor for measuring intensity of light; and
an image processing apparatus connected to the image scanner having;
a communication control section for obtaining, when reading an image of the slip, first light intensity information of another image recognizing apparatus connected to a network from the image recognizing apparatus, and
a control section for indicating the image scanner to read a slip, according to the first light intensity information from the image recognizing apparatus and second light intensity information from the light intensity sensor.

2. An image recognizing apparatus according to claim 1, wherein:
the image scanner includes a memory for storing the second light intensity information; and
the light intensity sensor measures intensity of light at a predetermined interval of time.

3. An image recognizing apparatus according to claim 1, wherein when intensity of light indicated by the first light intensity information is more than a threshold value and intensity of light indicated by the second light intensity information is less than the threshold value, the communication control section obtains again the first light intensity information after a lapse of a predetermined period of time.

4. An image recognizing apparatus according to claim 1, wherein when intensity of light indicated by the second light intensity information is more than a threshold value, the control section indicates the image scanner to read the slip.

5. An image recognizing apparatus according to claim 4, wherein the information processing apparatus includes an output device,
the output device outputting a warning message when intensity of light indicated by the first light intensity information is less than the threshold value.

6. An image recognizing apparatus according to claim 1, wherein the image scanner is an image scanner of stand type.

7. An image recognizing apparatus for obtaining image data of a slip and for recognizing characters in the image data, comprising:
a stand-type image reading device for reading an image of a slip and
an information processing apparatus for recognizing characters in the image of the slip, wherein:
the stand-type image reading device, comprises
a reading plate for setting a slip thereon,
a scanner for reading an image of a slip set on the reading plate, and
a light intensity sensor for measuring intensity of light on the reading plate; and
the information processing apparatus comprises
a communication board for obtaining, when reading an image of the slip, first light intensity information of another image recognizing apparatus connected to a network from the image recognizing apparatus,
the information processing apparatus obtaining, before indicating the stand-type image reading device to read a slip, second light intensity information regarding intensity of light on the reading plate from the light intensity sensor and then indicating the communication board to obtain the first light intensity information.

8. An image recognizing apparatus according to claim 7, wherein the information processing apparatus determines according to the first and second light intensity information whether or not the control section indicates the stand-type image reading device to read an image of a slip.

9. An image recognizing apparatus according to claim 7, wherein:
the stand-type image reading device includes a memory for storing the second light intensity information; and
the light intensity sensor measures intensity of light at a predetermined interval of time.

10. An image recognizing apparatus according to claim 7, wherein when intensity of light indicated by the first light intensity information is more than a threshold value and intensity of light indicated by the second light intensity information is less than the threshold value, the information processing apparatus indicates again the communication board to obtain the first light intensity information after a lapse of a predetermined period of time.

11. An image recognizing apparatus according to claim 7, wherein when intensity of light indicated by the second light intensity information is more than a threshold value, the information processing apparatus indicates the stand-type image reading device to read the slip.

12. An image recognizing apparatus according to claim 11, wherein the information processing apparatus includes an output device,
the output device outputting a warning message when intensity of light indicated by the first light intensity information is less than the threshold value.
